(19) United States
(12) Patent Application Publication
(10) Pub. No.: US 2010/0124937 A1
(43) Pub. Date: May 20, 2010

(54) METHOD OF CUSTOMER RELATIONSHIP MANAGEMENT USING A SHORT RANGE COMMUNICATIONS NETWORK

(76) Inventors: John Vogel, Mercer Island, WA (US); Mike Martinez, Issaquah, WA (US); Arthur Jason Gregory, Seattle, WA (US); Ville Aikas, Seattle, WA (US)

Correspondence Address: Vierra Magen Marcus & DeNiro LLP, 575 Market Street, Suite 2500, San Francisco, CA, 94105, US

(21) Appl. No.: 12/275,132

(22) Filed: Nov. 20, 2008

(51) Int. Cl. H04W 4/12; H04B 7/00

(52) U.S. Cl. 455/466; 455/41.2

(57) ABSTRACT

A method and system are disclosed for managing customer relationships, in part using a short range communications network. A business entity service center may include a Bluetooth station for detecting Bluetooth devices within range of the service. Once the station detects a Bluetooth device within range, the user of the device is given the opportunity to subscribe to the system. Once a customer subscribes to the system, the next time the customer's Bluetooth device is detected within range of the entity service center, a variety of personalized customer services may be performed for that customer. For example personalized welcome messages and/or discount offers may be sent to the detected Bluetooth device.

### BACKGROUND

1. Field of the Invention

Embodiments of the present invention relate to a method of managing customer relationships, in part using a short range communications network.

2. Description of the Art

Systems for managing customer relations using networked devices to facilitate communications are known. For example, applicants' co-pending U.S. application Ser. No. 12/166,655, entitled “Automated Interactive SMS Service System,” discloses a system where Short message service (SMS) is used by service representatives to facilitate customer relations and management largely through the use of SMS texts. For example, in an embodiment, the system may use SMS texts for automated and interactive confirmation of an appointment or other event and, if desired, rescheduling of the event.

SMS has become a popular text-based protocol for exchanging short text messages between cellular networks and wireless devices such as cellular phones. Different SMS implementations have been defined for different mobile networking protocols. For example, the SMS implementation for a Global System for Mobility (GSM) network is described in a document entitled “Teleservices Supported by a GSM Public Land Mobile Network (PLMN).” The SMS implementation for an ANSI-41 network is described in document TIA/EIA-637-B, entitled “Short Message Service for Wideband Spread Spectrum Systems.” Both of these documents are publicly available and are incorporated herein by reference.

One type of wireless protocol, which may or may not support SMS text, is the Bluetooth short-range wireless protocol. Bluetooth uses radio waves to allow connectivity between devices over short distances in an ad hoc wireless network. The Bluetooth protocol operates using radio waves in the 2.45 GHz frequency band (the Industrial-Scientific-Medical (ISM) band). The Bluetooth consortium of companies also developed de facto standards for the interface and the software that controls it to ensure interoperability of devices from different manufacturers that are using Bluetooth communications. In operation, each Bluetooth device is assigned an identifier referred to as a Media Access Control address (MAC address). A device's MAC address allows it to be identified on the short range wireless network to enable communications to and from that device.

Further details of the Bluetooth communications system are set forth in the papers, “Ericsson's Bluetooth Modules,” by Arfwedson and Sneddon, Ericsson Review No. 4, 1999, pp. 198-205, and “Bluetooth—The Universal Radio Interface for Ad Hoc, Wireless Connectivity,” by Jaap Haartsen, Ericsson Review No. 3, 1998, pp. 110-117, which papers are incorporated by reference in their entirety herein. Further details relating to the Bluetooth communications system may also be found in the Bluetooth Specification at the Bluetooth website (www.bluetooth.com), which Specification is also incorporated by reference in its entirety herein. Bluetooth has been shown capable of transmitting images. For example, “Error Resilient Image Transmission over a Bluetooth Network,” by Kelly et al., NUI, Galway Faculty of Engineering Research Day 2004, which is also incorporated by reference in its entirety herein, describes one methodology.

To date, there has been limited use of short range communications such as Bluetooth to manage customer relations. For example, it is known to transmit certain non-targeted advertisements to client devices such as mobile telephones via Bluetooth. However, Bluetooth and other short range communications protocols have not been used for targeted advertising or personalized communications as a result of associating a user profile with a particular MAC address or other identifier linked to a particular device.

### SUMMARY

Embodiments of the present system, roughly described, relate to a method of managing customer relationships, in part using a short range communications network. In particular, short range devices such as Bluetooth devices may be uniquely identified by their MAC address, which is transmitted when the device is within range of a Bluetooth station. In embodiments of the present invention, a business entity such as an auto dealership may include a Bluetooth station for detecting Bluetooth devices within range of the dealership. Once the station detects a Bluetooth device within range, the user of the device is given the opportunity to subscribe to the system of the present invention. For example, embodiments of the present system send a communication to the device, requesting the user of the device to reply with an SMS text message including a keyword identifier. If the user responds with the keyword, the user's cellular telephone number, transmitted with the text message, is stored in association with the MAC address for that device. The user may also be prompted for additional information (name, address, email, etc.) so that a user's profile may be stored in association with a MAC address.

Once a customer subscribes to the system, and a customer's profile has been associated with a Bluetooth MAC address, the next time that MAC address is detected within range of the dealership or other entity, a variety of personalized customer services may be performed for that customer. In one example, upon detecting a MAC address having an associated stored customer profile, the present system may cause a welcome message to be sent to the customer. For example, the present system may send an SMS text to the cellular telephone associated with a MAC address welcoming the user with a personalized message to the dealership or location. In a further example, instead of or in addition to a welcome message, a detected Bluetooth customer device may be sent discounts, coupons and other offers which may be targeted and personalized to the specific customer associated with the detected Bluetooth device.

In the embodiments, the Bluetooth station is located within an entity service center so as to detect when Bluetooth devices are within a given vicinity of the service center. However, in alternative embodiments, the Bluetooth station may be located remote from the service center. For example, the Bluetooth station may be set up at an event (sports, concerts, etc.), shopping mall or temporary location for the purpose of driving business to the remote service center or to a location associated with the event, mall or temporary location.

A further feature of embodiments of the present invention is that customers may receive personalized messages and offers even after hours or where a service center is otherwise closed. In such embodiments, when a user is within range of a service center when the center is closed, the user may still be given the option to subscribe to the service. If an already-subscribed user visits a closed service center, the user may receive welcome messages, after hours contact information and/or discount offers according to embodiments of the present invention.

### BRIEF DESCRIPTION OF THE DRAWINGS

FIG. 1 is a block diagram of a system for managing customer relations using in part a short range communications network.

FIG. 2 is a block diagram of one Bluetooth device which may operate with embodiments of the present invention.

FIG. 3 is a flowchart showing an embodiment of a method for subscribing users of Bluetooth devices to the system of the present invention.

FIG. 4 is a flowchart showing an embodiment of a method for providing a personalized customer service after a customer is subscribed to the system of the present invention.

FIGS. 5A and 5B are a flowchart showing a further embodiment of a method for providing a personalized customer service after a customer is subscribed to the system of the present invention.

### DETAILED DESCRIPTION

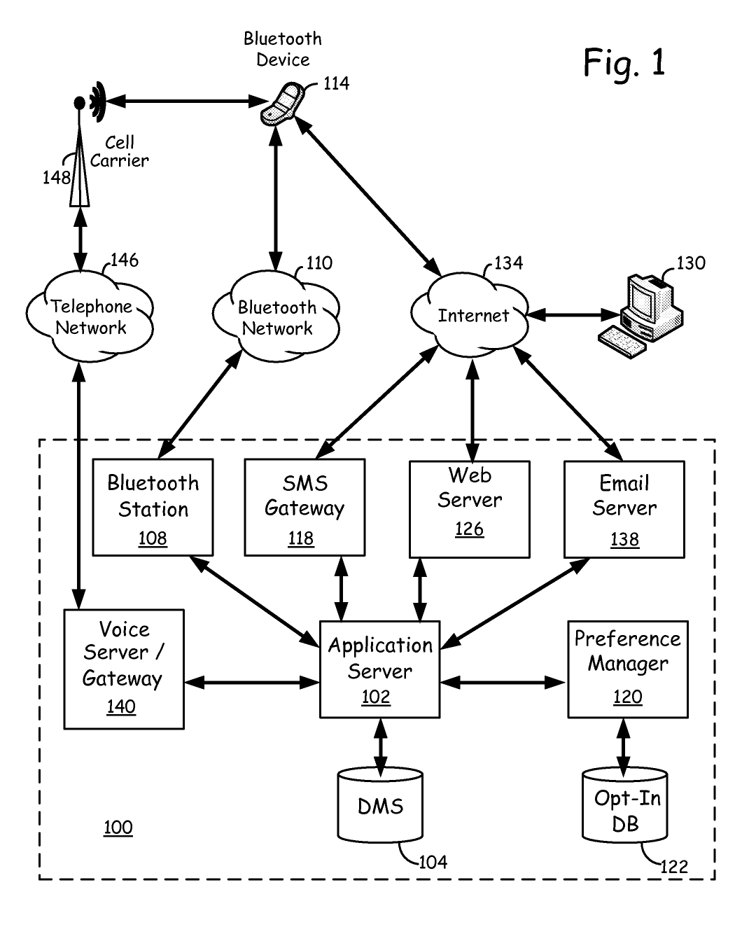

The present invention will now be described with reference to FIGS. 1 through 5B, which in general relate to a method of managing customer relationships, in part using a short range communications network. While the following description refers primarily to Bluetooth as the short range wireless network employed, it is understood that the present invention may operate over other short range wireless networks. Such other short range wireless networks include Wireless USB, 802.11, radio frequency (RF), infrared (IR), IrDA from the Infrared Data Association and home RF technologies.

It is further understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

FIG. 1 shows a block diagram of a system 100 for carrying out embodiments of the present invention. The system 100 includes an application server 102 executing an application program for associating a device identifier with a user profile, and for generating messages and responding to messages as explained hereinafter. In one embodiment, the system 100 may be used as an automated and interactive customer service tool for a business such as an automobile dealership or other dealership. Automobile dealerships may employ a dealership management system (DMS) 104 which, as is known in the art, may be a database used by a dealership to track a wide variety of information relating to its business, including for example vehicle inventory, sales, financing, automobile service records, customers, customer transactions and appointment scheduling. DMS 104 may store data relating to additional dealership functions. It is understood that embodiments of the present invention may be used for businesses other than automobile dealerships, which may have a DMS 104, or alternatively some other database for storing customer profile and service records or other information.

In embodiments, the system 100 includes a Bluetooth station 108 connected to a short range wireless network 110. As explained in greater detail below, the Bluetooth station 108 includes a Bluetooth radio which is able to sense the presence of Bluetooth devices 114 within a given distance of the Bluetooth station 108. While the Bluetooth device 114 is illustrated as a mobile telephone in FIG. 1, it is understood that Bluetooth device 114 may be any of a variety of Bluetooth enabled devices, including for example personal digital assistants and other network-connected handheld devices, laptops and automobiles. As indicated above, station 108, network 110 and device 114 may operate by short range protocols other than Bluetooth in further embodiments.

After a Bluetooth device 114 is associated with a customer profile as explained below, communications with device 114 may be had by a variety of communication methods, including SMS text. SMS text may be sent between application server 102 and device 114 via an SMS gateway 118. As explained below, communications to and from the SMS gateway 118 may be with the Bluetooth device 114, or other SMS enabled devices specified in a customer profile. It is also understood that text messages may be exchanged by protocols other than SMS.

In embodiments, text messages are transferred to and from system 100 via SMS gateway 110 by short message peer-to-peer protocol (SMPP). Messages may be transferred by other technologies in further embodiments, including via the Bluetooth or other short range protocol. SMS messages may be sent to GSM-capable cellular telephones, but SMS messages may be sent to phones operating by other standards in alternative embodiments.

System 100 additionally includes a preference manager 120 and an opt-in database 122. As explained hereinafter, before the system 100 interacts with an end user in certain embodiments, the end user must subscribe, or opt into, the services provided by the system 100. Accordingly, preference manager 120 is provided to manage the opt-in process, and opt-in database 122 is provided to store the identity and customer profiles of all end users who have opted into the services of system 100.

System 100 further includes a web server 126 for allowing an entity 130 such as an automobile or other dealership or business to access the system 100 via a network 134, which may for example be the Internet. An entity 130 may upload information to the DMS 104 via the web server 126. An email server 138 is further provided within system 100 for the exchange of emails between entity 130 and end users as explained hereinafter. System 100 may additionally include a voice server/gateway 140 for bridging telephone calls between entity 130 and a customer device 114 via a telephone network 146 and cell carrier 148. It is understood that system 100 may include additional components and/or that one or more of the above-described components may be omitted in certain embodiments.

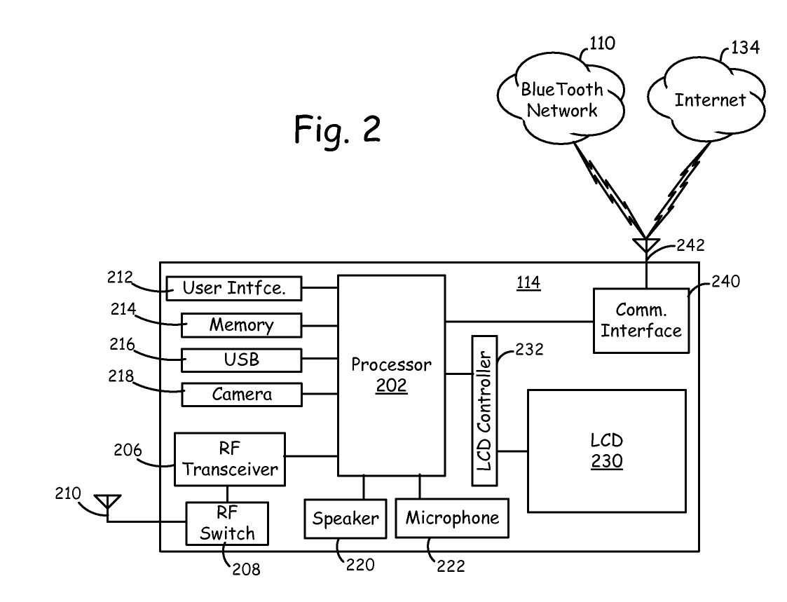

As indicated, device 114 may be a variety of Bluetooth-enabled devices. FIG. 2 is a block diagram of an example where device 114 is a Bluetooth-enabled cellular telephone. Device 114 may have a conventional hardware configuration and may operate to perform all of the functions conventionally known for mobile telephones. Device 114 may include a processor 202, which may be part of or include a digital baseband and/or an analog baseband for handling digital and analog signals. As is known, processor 202 may include a variety of electronics for handling incoming and outgoing digital voice and data signals.

RF Transceiver 206 and switch 208 are provided for receiving and transmitting analog signals, such as an analog voice signal, via an antenna 210. In embodiments, transceiver 206 performs the quadrature modulation and demodulation, as well as up- and down-conversion from dual-band (800 and 1900 MHz) RF to baseband. The various communication interfaces described herein may include a transceiver and/or switch as in transceiver 206 and switch 208.

Device 114 may further include a user interface 212 for user interaction with device 114, memory 214 for storing contact information and pictures, graphics, audio and other files and applications. Memory 214 may be a dedicated and/or removable memory. Device 114 may further include a connection 216 for connecting device 114 to another device. Connection 216 may be a USB connection, but it is understood that other types of connections may be provided, including serial, parallel, SCSI and an IEEE 1394 (“Firewire”) connection. Device 114 may further include a camera 218, speaker 220, a microphone 222 as are known in the art. Text and graphics may be displayed on an LCD display 230, which may communicate with processor 202 via an LCD controller 232. Device 114 may further include a communication interface 240 capable of wireless communication with the Bluetooth network 110 and/or the Internet 134 shown in FIG. 1.

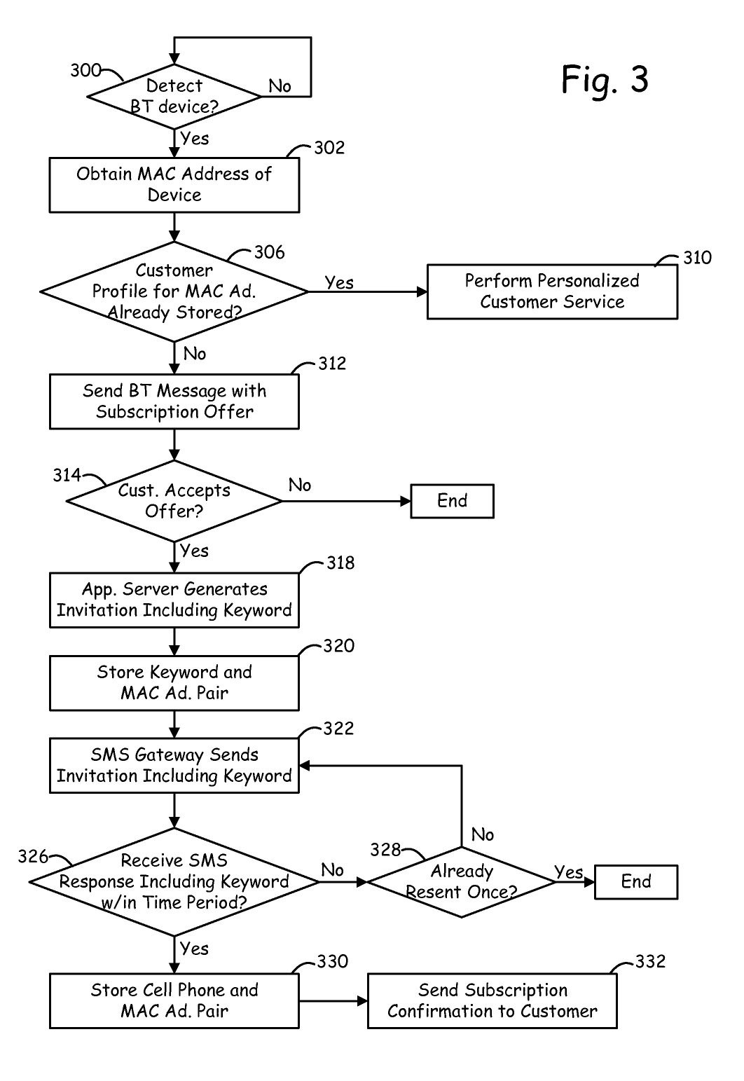

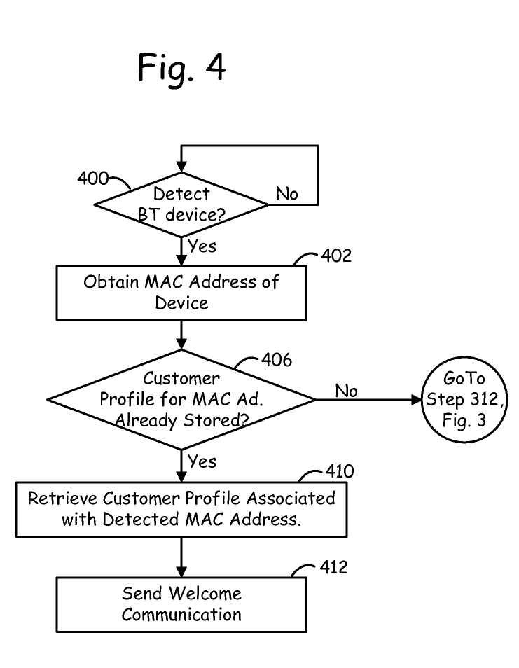

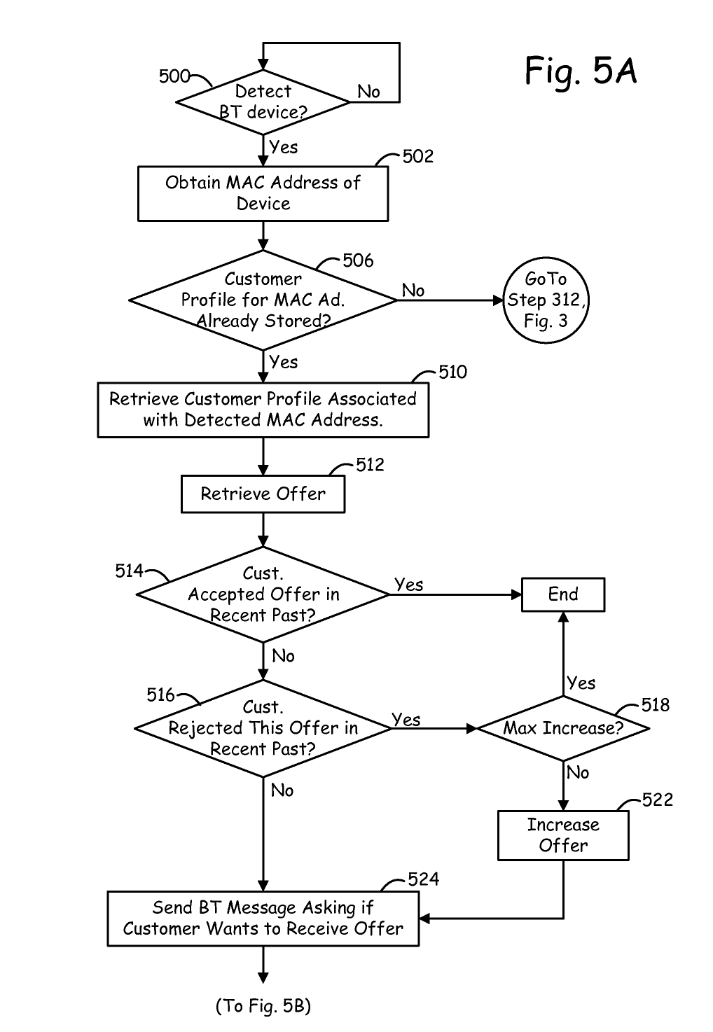

The operation of system 100 will now be described with respect to the flowcharts of FIGS. 3-5B. Initial detection and subscription to the service provided by system 100 is first explained with reference to FIG. 3. In step 300, the system first looks for a Bluetooth device 114. Namely, the Bluetooth station 108 searches for Bluetooth devices within range of the Bluetooth station radio. The Bluetooth station 108 may be located at a physical location of the entity's customer service center, but as explained below, it may be located remotely in alternative embodiments.

If a Bluetooth device 114 is detected in step 300, the MAC address of the device is obtained in step 302 and provided to the application server 102. While embodiments of the present invention detect a MAC address and then store a user profile in association with that MAC address, it is understood that other unique or quasi unique identifiers that are associated with particular devices in a short range wireless network may be used instead of MAC addresses in alternative embodiments.

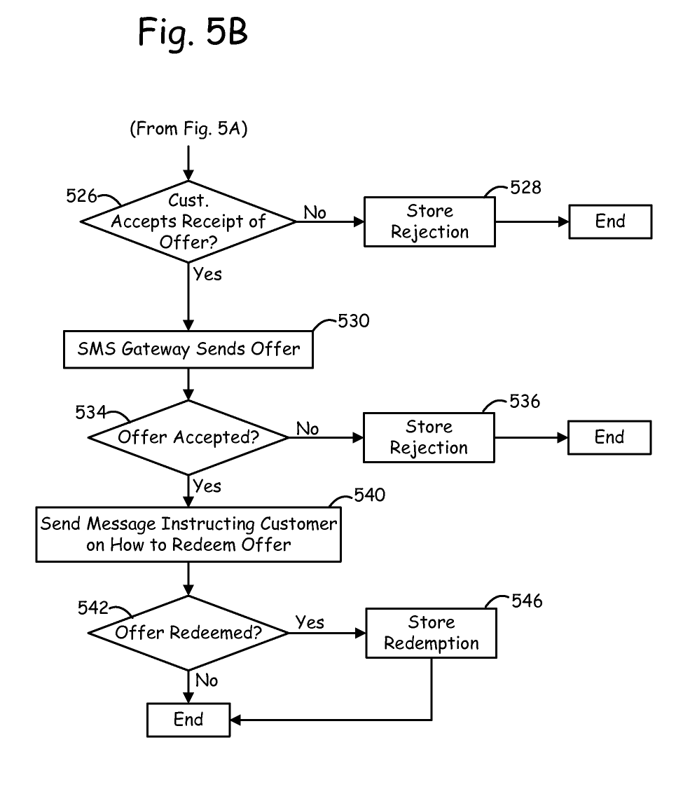

In step 306, the application server 102 determines whether there is already a customer profile associated with the obtained MAC address. If there is, then the application server performs some personalized customer service in step 310 as explained hereinafter with respect to FIGS. 4, 5A and 5B. If the application server determines that there is no customer profile associated with the obtained MAC address in step 306, then the application server generates a Bluetooth subscription offer message in step 312. The offer message is sent via the Bluetooth station 108 to the device 114 for example via the Bluetooth Object Push Profile (OPP). As is known, OPP is a protocol allowing the system 100 to send objects such as text, graphics and other files to devices 114 via the Bluetooth standard.

The subscription offer message may be any of a variety of messages indicating that there is an offer that a sender is attempting to send, and asking the customer if they are willing to accept receipt of the offer. The text may be something along the lines of, “Incoming item ‘Offer.gif’ from Smith Autodealer—Accept? YES or NO.” This is by way of example only, and the text may vary in further embodiments.

In step 314, the Bluetooth station 108 looks for a response. If a user does not respond, or responds NO, the present system goes no further with that user. The system returns to step 300 to search for further Bluetooth devices 114 within the vicinity. In embodiments, upon a NO or non response, the user may be placed on an opt-out list, in which case the user receives no further messages upon coming within Bluetooth range of the customer service center. The user may further respond that the user does not wish to receive communications from this service center. Upon receiving such an indication, the user may be placed on the opt-out list, in which case the user receives no further messages upon coming within Bluetooth range of the customer service center. The user may also be placed on the opt-out list if they reject some predefined number of attempted contacts in a row, such as for example two or three attempted contacts. The opt-out list may for example be stored in database 122 (FIG. 1).

However, if the user responds YES in step 314 (or otherwise indicates acceptance of the offer), the response is communicated via the Bluetooth station 108 to the application server 102, which then generates an invitation including a keyword in step 318. The keyword may be any word or character string. It may be short so that a user receiving it can remember it (for reasons set forth below), but the keyword should have sufficient characters so that a number of keywords may be generated within a given period of time without having to repeat keywords within that period of time.

The generated keyword is associated by the application server with the MAC address for the responding Bluetooth device 114, and the keyword/MAC address pair is stored in memory in step 320. The application server 102 then sends the invitation including the keyword to the customer in step 322 via the Bluetooth station 108. The invitation may be something like, “Text ‘apple’ to 30629 to enroll in Smith Autodealer Awards Club.” In this example, the keyword is “apple.” The customer accepts the invitation by sending the keyword to the included number (here, “30629”) via SMS text. This is by way of example only, and the text including the keyword and text return number may vary in alternative embodiments.

In embodiments, Bluetooth device 114 is a cellular phone. Often cellular phone service providers regulate when and under what conditions content may be automatically pushed to their users' phones. As such, steps 306-312 of sending a Bluetooth message asking whether the customer would like to receive the invitation are included. However, in embodiments where there is no such regulation (so that entities are free to push messages to users via a Bluetooth network), steps 306-312 may be omitted, and the invitation of step 322 may simply be sent.

After the SMS invitation is sent, the SMS gateway 118 looks for a reply in step 326. If no reply is received (or if a reply other than an expected keyword is received) within a predetermined period of time, the system may resend the keyword to the user in step 328. If the system has already resent the message once before and the expected keyword is still not received, the system may simply end without resending the keyword invitation again. It is understood that the system may resend the keyword more than once, or not at all, in alternative embodiments.

If, however, an SMS text is received and the application server confirms the SMS text includes a pending keyword, the application server then associates the customer's cellular telephone number with the MAC address stored with the pending keyword in step 330. In particular, the incoming SMS text message will include the user's cellular telephone number. The system is able to determine whether the incoming SMS text includes a pending keyword; that is, a keyword that: 1) has been sent out in an invitation within a predetermined period of time of the incoming SMS text, and 2) has not been received from another Bluetooth device within the predetermined period of time.

Assuming the response in step 326 includes a pending keyword, the customer's cellular telephone number in the incoming SMS text is then associated with the MAC address stored for the pending keyword. The associated cellular telephone number and MAC address pair is stored in memory in step 330. The application server may then send a confirmation and welcome message to the new customer in step 332 (in SMS text via the SMS gateway 118, or via Bluetooth text via the Bluetooth station 108).

Once a customer is enrolled as described above, additional information may be obtained and stored relating to the customer (in response to a request for more information or upon the user visiting an entity service center). This additional information may include the customer's name, address, email and/or alternate contact information, as well as a preferred mode of communication (SMS text, email or phone call). The additional information may further include products, services and/or offers which the customer has received from the service center, as well as service records the service center has for the customer. In this way, in addition to a cellular telephone number, a whole customer profile may be stored in association with a particular Bluetooth MAC address. In embodiments, the customer profile associated with a particular Bluetooth MAC address may be only the customer's cellular telephone number.

Once a customer profile has been associated with a Bluetooth MAC address, the next time that MAC address is detected within range of the Bluetooth station 108, a variety of personalized customer services may be performed for that customer (step 310). Examples of such personalized customer services are explained with respect to the flowcharts of FIGS. 4-5B.

In the example of FIG. 4, the Bluetooth station 108 looks for Bluetooth devices within range in step 400. Upon detecting such a device, the station 108 obtains the MAC address for the detected device (step 402) and checks whether the MAC address is associated with a stored profile (step 406). If not, the system carries out the steps for subscribing a customer as described above with respect to the flowchart of FIG. 3. However, assuming there is a profile associated with the detected device, the application server retrieves the profile in step 410.

In step 412, the application server may cause a welcome message to be sent to the customer. For example, the application server may send an SMS text via the SMS gateway 118 to the cellular telephone associated with that MAC address welcoming the user with a personalized message to the dealership or location. The message may or may not include information relating to a product, scheduled appointment or service history. One of many examples may be, “Welcome Mr. Jones. Sales representative Doe is waiting to discuss your service appointment for your Chevy Tahoe.”

The application server may alternatively or additionally send the welcome message in an email via the email server 138 to an email address associated with that MAC address. As a further option, the application server may alert a customer service representative, who may then initiate a telephone call via the voice server/gateway 140 to the cellular telephone associated with that MAC address welcoming the user to the dealership or location. Instead of or in addition to the above, the customer service representative may simply be on hand to greet the customer by name, and have an awareness of the purpose of the visit (for example if the customer is there for a service appointment).

Referring now to FIGS. 5A and 5B, a further customer service enabled by the present invention is to offer discounts, coupons and other offers which may be targeted and personalized to specific customers. In this example, the Bluetooth station 108 looks for Bluetooth devices within range in step 500. Upon detecting such a device, the station 108 obtains the MAC address for the detected device (step 502) and checks whether the MAC address is associated with a stored profile (step 506). If not, the system carries out the steps for subscribing a customer as described above with respect to the flowchart of FIG. 3. However, assuming there is a profile associated with the detected device, the application server retrieves the profile in step 510, and retrieves an offer in step 512. The offer may be any of a variety of incentives the service agent has elected to offer at that time. There may be a single offer running, or there may be several offers running, with the application server having rules to apply in order to determine which offer to make to which customers. The offers may include electronic coupons, sent as described below, for discounts or other incentives to purchase goods and/or services at the service center or elsewhere.

In step 514, the application server determines whether this customer has accepted this same offer within a predetermined period of time in the past (for example from the beginning of the current run of this offer). If so, the customer is not given the offer again, and the execution by the application server ends. The system then returns to step 500 to search for further Bluetooth devices 114 within the vicinity. It is understood that the same customer may be given the same offer more than once in a given period of time in alternative embodiments.

Assuming this customer has not accepted this offer within a predetermined period of time in the past, the application server next checks in step 516 if the customer has rejected this same offer in the past (as explained below, rejections are stored by the application server). If so, embodiments of the present invention may increase the offer (by for example offering coupons worth more, or giving a bigger discount, than an initial offer for products and/or services). First, the application server checks whether the offer has been increased to some predetermined maximum in step 518 as a result of prior increases made to the customer for the offer. If so, no further discounts are offered and the execution by the application server ends. If the predetermined maximum has not been reached, the offer may be increased in step 522.

In step 524, the application server 102 sends a message via the Bluetooth station 108, for example by OPP, asking the customer if they are interested in receiving an offer. The offer message may be any of a variety of messages indicating that there is an offer that a sender is attempting to send, and asking the customer if they are willing to accept receipt of the offer. The text may be something along the lines of, “Incoming item ‘10% discount offer.gif’ from Smith Autodealer—Accept? YES or NO.” This is by way of example only, and the text may vary in further embodiments.

In step 526, the Bluetooth station 108 looks for a response. If a user does not respond, or responds NO, the application server stores the rejection in step 528, and the present system goes no further with the offer to that user. The system returns to step 500 to search for further Bluetooth devices 114 within the vicinity. However, if the user responds YES in step 526 (or otherwise indicates acceptance of the offer), the response is communicated via the Bluetooth station 108 to the application server 102, which then sends the offer in step 530. As there is a profile stored in association with the detected MAC address, once the offer is accepted, the offer may be sent to the user as an SMS text via the SMS gateway 118, or by other communication modes.

After the offer is sent, the application server 102 looks for a reply in step 534. If no reply is received (or if a reply other than an acceptance is received) within a predetermined period of time, the application server stores the rejection in step 536, and the present system goes no further with the offer to that user. The system returns to step 500 to search for further Bluetooth devices 114 within the vicinity. The system may alternatively resend the offer if a response is not received within a predetermined period of time.

If, however, a response is received and the application server confirms the response is an acceptance of the offer, the application server then sends a further message in step 540 giving the offer and instructing the customer how to redeem the offer. The offer may for example indicate that the user is being given some percentage discount off a service or product, and that they should check in with the service center to redeem the discount. The offer may be sent by SMS text, but may alternatively be sent by a variety of other mediums, including email or direct telephone call. In step 542, the application server checks whether a particular user has redeemed the offer. For example, a service representative assisting the customer may upload that the user has redeemed an offer in step 546. The system may then return to step 500 to search for further Bluetooth devices 114 within the vicinity.

In the embodiments described above, the Bluetooth station 108 detects whether Bluetooth devices are within a given vicinity of a service center. However, in alternative embodiments, the Bluetooth station 108 may be located remote from the service center. In this embodiment, a Bluetooth station 108 may be set up at an event (sports, concerts, etc.), shopping mall or temporary location for the purpose of driving business to the remote service center or to a location associated with the event, mall or temporary location. Embodiments where the Bluetooth station 108 is not located within a given service center may operate per any of the above-described embodiments.

A further advantage of embodiments of the present invention is that customers may receive personalized messages and offers even after hours or where a service center is otherwise closed. In such embodiments, when a user is within range of a service center, a user may be given the option to subscribe as described above with respect to FIG. 3. If already subscribed, a user may be welcomed as described above with respect to FIG. 4, with a further message indicating that the service center is then closed, but they can try again tomorrow. Alternatively, they may be given contact information (for example by an SMS text message automatically generated by the application server) for someone they can contact who is on call after hours. A user may also receive special offers when a service center is closed as described above with respect to FIGS. 5A and 5B. Those of skill in the art will appreciate other possible uses of a system which associates a MAC address, or other identifier, with a user profile, so that contact may be made with the user when the user is detected within the vicinity of a service center or other location hosted by the service center.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

We claim:

1. A method of managing customer relations, comprising the steps of:
(a) detecting an identifier of a short range communications device within range of a short range communications station via a short range communications network;
(b) requesting a user of the detected device to subscribe to a service by sending a reply from the device detected in said step (a), the reply including identification information for the user;
(c) associating the identification information received in said step (b) with the identifier detected in said step (a); and
(d) sending a communication to a device when the device is detected by the short range communications station after a user has subscribed to the service, the communication personalized using at least in part the identification information received in said step (b).

2. The method of claim 1, wherein said step (a) of detecting an identifier of a short range communications device comprises the step of detecting a MAC address of a Bluetooth device.

3. The method of claim 1, wherein said step (b) of requesting a user of the detected device to subscribe to a service by sending a reply from the detected device comprises the step of sending a communication via the short range communications network to the detected device requesting the user to respond with a keyword to a specified contact number.

4. The method of claim 1, wherein said step (b) of requesting a user of the detected device to subscribe to a service by sending a reply from the detected device comprises the step of sending a first communication via the short range communications network asking the user if they are interested in receiving a second communication regarding subscription.

5. The method of claim 4, wherein said step (b) of requesting a user of the detected device to subscribe to a service by sending a reply from the detected device comprises the step of sending the second communication via the short range communications network to the detected device requesting the user to respond with a keyword to a specified contact number.

6. The method of claim 1, wherein said step (b) of requesting a user of the detected device to subscribe to a service by sending a reply including identification information for the user comprises the step of requesting the user to send an SMS text message from their cellular telephone, the cellular telephone number being identifiable upon receipt of the SMS text message.

7. The method of claim 1, wherein said step (d) of personalizing the sent communication using at least in part the identification information received in said step (b) comprises the step of sending a personalized welcome message via SMS text to the device detected in said step (a).

8. The method of claim 7, wherein said step (d) of sending a personalized welcome message via SMS text to the device comprises sending a welcome message including at least one of a customer's name, a product or service purchased in the past and a purpose for the current visit.

9. The method of claim 1, wherein said step (d) of personalizing the sent communication using at least in part the identification information received in said step (b) comprises the step of sending discount offers via SMS text to the device detected in said step (a), the discount offers customized to the subscribed customer.

10. The method recited in claim 1, wherein the short range communications station is located within a service center responsible for sending the communication in said step (d).

11. The method recited in claim 1, wherein the short range communications station is located remote from a service center responsible for sending the communication in said step (d).

12. A method of managing customer relations, comprising the steps of:
(a) detecting an identifier of a short range communications device within range of a short range communications station via a short range communications network;
(b) associating the identifier detected in said step (a) with a keyword;
(c) requesting a user of the detected device to send a reply from the detected device including the keyword, the reply further including identification information relating to the detected device;
(d) associating the identification information accompanying receipt of the keyword with the identifier detected in said step (a); and
(e) sending a communication to a device when the device is detected by the short range communications station after the identification information has been associated with the identifier in said step (d), the communication personalized using at least in part the identification information received in said step (c).

13. The method of claim 12, wherein the identification information included in the reply requested in said step (c) is the telephone number of a telephone sending the reply.

14. The method of claim 12, wherein said step (e) of sending a communication to a device when the device is detected by the short range communications station after the identification information has been associated with the identifier in said step (d) comprises the step of texting a personalized communication to a telephone having an identifier detected by the short range communications station.

15. The method of claim 12, wherein the identification information included in the reply requested in said step (c) is the telephone number of a telephone sending the reply, and further comprising the step of obtaining identification information from the user in addition to the telephone number.

16. The method of claim 15, wherein said step (e) of personalizing the sent communication using at least in part the identification information comprises the step of sending a personalized welcome message via SMS text to the device detected in said step (a).

17. The method of claim 16, wherein said step (d) of sending a personalized welcome message via SMS text to the device comprises sending a welcome message including at least one of a customer's name, a product or service purchased in the past and a purpose for the current visit.

18. The method of claim 15, wherein said step (d) of personalizing the sent communication using at least in part the identification information received in said step (b) comprises the step of sending discount offers via SMS text to the device detected in said step (a), the discount offers customized to the owner of the device detected in said step (a).

19. A method of managing customer relations, comprising the steps of:
(a) detecting a MAC address of a Bluetooth enabled mobile phone within range of a Bluetooth communications station via a Bluetooth communications network;
(b) associating the MAC address detected in said step (a) with a keyword;
(c) requesting a user of the detected mobile phone to send a text message from the detected mobile phone including the keyword to a specified number, the reply including the cellular phone number of the mobile phone; and
(d) storing the cellular telephone number accompanying receipt of the keyword in association with the MAC address detected in said step (a).

20. The method recited in claim 19, further comprising the step (e) of sending a personalized text message to a cellular phone when the phone is detected by the Bluetooth communications station after the cellular phone number has been stored in association with the MAC address in said step (d).

21. The method recited in claim 20, wherein said step (e) of sending the personalized text message to the cellular phone comprises the step of sending a personalized welcome message to the cellular phone.

22. The method of claim 21, wherein said step (e) of sending a personalized welcome message comprises sending a welcome message including at least one of a customer's name, a product or service purchased in the past and a purpose for the current visit.

23. The method of claim 20, wherein said step (e) of sending the personalized text message to the cellular phone comprises the step of sending discount offers to the cellular phone, the discount offers customized to the owner of the cellular phone.

24. The method recited in claim 20, wherein the Bluetooth communications station is located within a service center responsible for sending the personalized text message.

25. The method recited in claim 20, wherein the Bluetooth communications station is located remote from a service center responsible for sending the personalized text message.
